(19) United States
(12) Patent Application Publication
(10) Pub. No.: US 2010/0301241 A1
(43) Pub. Date: Dec. 2, 2010

(54) VALVE ASSEMBLY WITH DUMMY ELECTRICAL CONNECTOR PORT

(75) Inventors: Joel LaBenz, Chandler, AZ (US); David Pantier, Gilbert, AZ (US); Scott Martin, Mesa, AZ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/473,091

(22) Filed: May 27, 2009

(51) Int. Cl. F16K 31/02

(52) U.S. Cl. 251/129.01

(57) ABSTRACT

A valve assembly includes a valve body, a valve element, a valve actuator, a main connector port, and a dummy connector port. The main connector port is coupled to the valve body and is electrically coupled to the valve actuator. The main connector is also adapted to mechanically and electrically mate to an electrical harness. The dummy connector port is coupled to the valve body and is disposed proximate the main connector port. The dummy connector port is electrically isolated from the valve actuator and is adapted to at least mechanically mate to the electrical harness in a manner that is at least substantially identical to the manner in which the electrical connector mechanically mates to the main connector port.

### TECHNICAL FIELD

The present invention generally relates to valve assemblies and, more particularly, to a valve assembly with a dummy electrical connector port.

### BACKGROUND

Valves are installed in myriad systems where it is needed or desired to control the flow of a fluid. Many different specific valve types exist. In general, however, most include a valve body and a valve element. The valve body has at least one flow passage defined therein, and the valve element is disposed within the flow passage and is positioned to control fluid flow through the flow passage. In many instances, it may be desirable to control the position of the valve element via an actuator. Various types of actuators have been, and continue to be, used to implement this function. These include electric, hydraulic, pneumatic, electro-hydraulic, and electro-pneumatic actuators, just to name a few.

Electrical valve actuators are typically configured to receive actuator commands from an external control device and, in response to these commands, supply a drive torque to the valve element to move the valve element to the commanded position. Valves that include electrical actuators often include a manual locking feature that may be used to manually position the valve to a desired position, and lock the valve in that desired position. One of the more common reasons for implementing this feature is to override the valve if it is no longer functioning normally.

Nonetheless, merely locking a valve into a desired position does not disable the valve actuator from receiving actuator commands. Hence, to maintain the valve element in the locked position in the event actuator commands are received, the manual locking feature is designed generally robustly so that it can withstand the potential drive torque from the actuator. Another, less desirable way to alleviate this is to disconnect, at the valve, the electrical harness that supplies the actuator commands to the actuator. This, however, leaves the end of the harness unsupported and open to the environment, increasing the possibility of damaging the harness.

Hence, there is a need for a device and method of preventing valve actuator commands from being supplied to an electric valve actuator when, for example, the valve element is manually locked in a desired position. The present invention addresses at least this need.

### BRIEF SUMMARY

In one exemplary embodiment, a valve assembly includes a valve body, a valve element, a valve actuator, a main connector port, and a dummy connector port. The valve body has a fluid inlet, a fluid outlet, and a flow passage between the fluid inlet and the fluid outlet. The valve element is disposed at least partially within the flow passage and is moveable between a closed position and an open position. The valve actuator is mounted on the valve body and is coupled to the valve element. The valve actuator is adapted to receive actuator commands and is operable, upon receipt of the actuator commands, to move the valve element to the closed position or the open position. The main connector port is coupled to the valve body and is electrically coupled to the valve actuator. The main connector is adapted to mechanically and electrically mate to an electrical harness. The dummy connector port is coupled to the valve body and is disposed proximate the main connector port. The dummy connector port is electrically isolated from the valve actuator and is adapted to at least mechanically mate to the electrical harness in a manner that is at least substantially identical to the manner in which the electrical connector mechanically mates to the main connector port.

In another exemplary embodiment, a method of manufacturing a valve assembly includes forming a valve body having a fluid inlet, a fluid outlet, and a flow passage between the fluid inlet and the fluid outlet. A valve element is disposed at least partially within the flow passage, and a valve actuator is mounted on the valve body. The valve actuator is to the valve element, is adapted to receive actuator commands, and is operable, upon receipt of the actuator commands, to move the valve element to a closed position or an open position. A main connector port and a dummy connector port are both coupled to the valve body. The main connector port is adapted to mechanically and electrically mate to an electrical harness, and is electrically coupled to the valve actuator. A dummy connector port is adapted to at least mechanically mate to the electrical harness in a manner that is at least substantially identical to the manner in which the electrical connector mechanically mates to the main connector port, but remains electrically isolated from the valve actuator.

In still a further exemplary embodiment, a valve control system includes an electrical harness and a valve assembly. The electrical harness is coupled to receive and transmit electrical valve actuator commands. The valve assembly includes a valve body, a valve element, a valve actuator, a main connector port, and a dummy connector port. The valve body has a fluid inlet, a fluid outlet, and a flow passage between the fluid inlet and the fluid outlet. The valve element is disposed at least partially within the flow passage and is moveable between a closed position and an open position. The valve actuator is mounted on the valve body and is coupled to the valve element. The valve actuator is coupled to receive the electrical actuator commands and is operable, upon receipt of the actuator commands, to move the valve element to the closed position or the open position. The main connector port is coupled to the valve body and is electrically coupled to the valve actuator. The main connector port is mechanically and electrically mated with the electrical harness. The dummy connector port is coupled to the valve body, and is electrically isolated from the valve actuator. The dummy connector port is adapted to at least mechanically mate to the electrical harness in a manner that is at least substantially identical to the manner in which the electrical connector mechanically mates to the main connector port. Thus, when the electrical harness mates with the dummy connector port, any electrical valve actuator commands received by the electrical harness are not electrically coupled to the valve actuator.

Furthermore, other desirable features and characteristics of the valve assembly and dummy connector will become apparent from the subsequent detailed description and the appended claims, taken in conjunction with the accompanying drawings and the preceding background.

### BRIEF DESCRIPTION OF THE DRAWING

The present invention will hereinafter be described in conjunction with the following drawing figure, wherein like numerals denote like elements, and wherein:

FIG. 1, which is the sole figure, is a cutaway view of an exemplary valve assembly of the present invention.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. In this regard, although the present invention is described as being implemented in the context of an electrically controlled butterfly valve, it will be appreciated that the invention is not limited to butterfly valves, but may be implemented with numerous other types of electrically controlled valves.

The valve assembly 100 includes a valve body 102, a valve element 104, and an actuator 106. The valve body 102 includes a fluid inlet 101, a fluid outlet 103, and an inner surface 108 that defines a flow passage 112 between the fluid inlet 101 and fluid outlet 103. The valve body 102 may be made of any one of numerous suitable materials. Examples of suitable materials include, but are not limited to, aluminum alloys, steel, and titanium. Although a single flow passage 112 is depicted, it will be appreciated that multiple flow passages may alternatively be formed in the valve body 102.

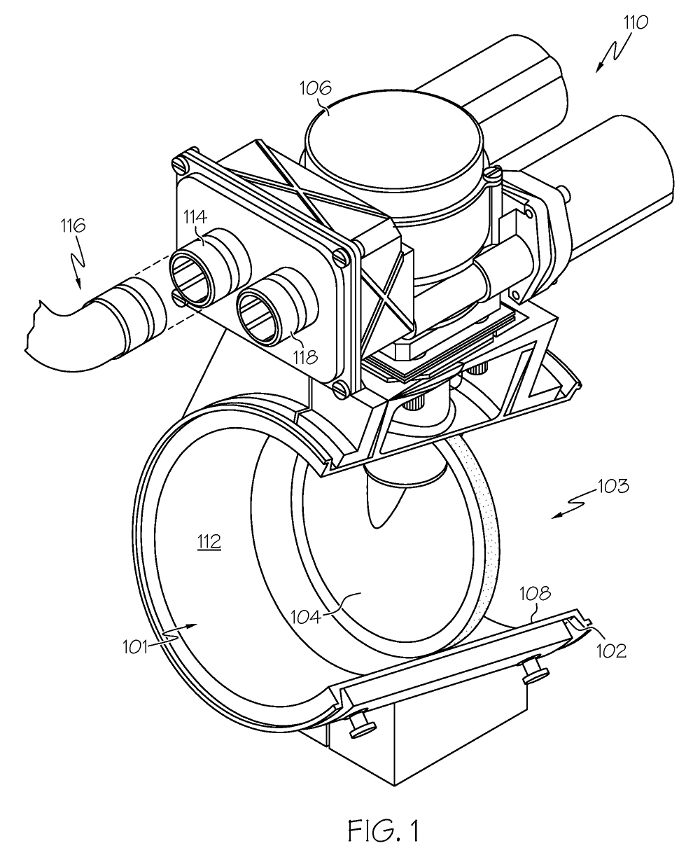

The valve element 104 is disposed within (or at least partially within) the flow passage 112, and is rotationally mounted to the valve body 102. In the depicted embodiment, the valve element 104 is implemented as a butterfly plate. It will be appreciated, however, that this is merely exemplary, and that the valve element 104 may be implemented as any one of numerous other suitable types of valve elements. In any case, the valve element 104 is movable between a closed position, which is the position depicted in FIG. 1, and an open position. In the closed position, fluid flow through the flow passage 112 is prevented (or at least substantially inhibited). In an open position, fluid may flow through the flow passage 112.

The actuator 106 is mounted on the valve body 102 and is coupled to the valve element 104. The valve actuator 106 is adapted to receive actuator commands that originate in, for example, a non-illustrated control device. The valve actuator 106 is operable, upon receipt of the actuator commands, to supply a drive torque that moves the valve element to the closed position or an open position consistent with the actuator commands.

The actuator commands that originate in the non-illustrated control device are supplied to the valve assembly 100, and more specifically the valve actuator 106, via an a main connector port 114 and an electrical harness 116. The main connector port 116 is coupled to the valve body 102 and is electrically coupled to the valve actuator 106 via suitable, non-illustrated conductors. The main connector 114 is configured to mechanically and electrically mate to the electrical harness 116 in any one of numerous suitable, well known manners. The electrical harness 116 is coupled to receive electrical valve actuator commands from the non-illustrated control device, and to transmit the electrical valve actuator commands to the main connector port. The main connector port 114 and electrical harness 116 are configured such that the electrical valve actuator commands are transmitted through the main connector port 114 and to the valve actuator 106.

As FIG. 1 depicts, the valve assembly 100 further includes a second electrical connector port 118. This second electrical connector port 118 is referred to herein as a dummy connector port. The dummy connector port 118, similar to the main connector port 114, is coupled to the valve body 102. Preferably, and as FIG. 1 depicts, the dummy connector port 118 is disposed proximate the main connector port 114. It will be appreciated, however, that disposing the dummy connector port 118 proximate the main connector port 114 is not required. No matter it specific location, the dummy connector port 118, unlike the main connector port 114, is electrically isolated from the valve actuator 106. The dummy connector port 118 is, however, configured to at least mechanically mate to the electrical harness 116 in a manner that is identical (or at least substantially identical) to the manner in which it mechanically mates to the main connector port 114.

With the above described configuration, it will be appreciated that whenever the electrical harness 116 is mated to the dummy connector port 118, if any electrical valve actuator commands are received by the electrical harness 116, these commands will not be electrically coupled to the valve actuator 106. Thus, if the valve element 104 is moved to, and locked in, a desired position via a non-illustrated manual locking mechanism, the electrical harness 116 may be disconnected from the main connector port 114 and mated to the dummy connector port 118.

Though not depicted in FIG. 1, it will be appreciated in a preferred embodiment that the main connector port 114 and dummy connector port 118 are suitably labeled or otherwise coded with appropriate identifying indicia. It will additionally be appreciated that the dummy connector port 118 is preferably manufactured from a relatively lightweight, yet suitably durable material. In this manner, this additional component will not significantly increase the overall weight of the valve assembly 100. Preferably, the dummy connector port 118 is lighter in weight than the main connector port 114, and thus comprises a material that is lighter in weight than that of the main connector 114. For example, the dummy connector 118 may comprise a suitable plastic material.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A valve assembly, comprising:
a valve body having a fluid inlet, a fluid outlet, and a flow passage between the fluid inlet and the fluid outlet;
a valve element disposed at least partially within the flow passage and moveable between a closed position and an open position;
a valve actuator mounted on the valve body and coupled to the valve element, the valve actuator adapted to receive actuator commands and operable, upon receipt of the actuator commands, to move the valve element to the closed position or the open position;
a main connector port coupled to the valve body and electrically coupled to the valve actuator, the main connector adapted to mechanically and electrically mate to an electrical harness; and
a dummy connector port coupled to the valve body and disposed proximate the main connector port, the dummy connector port electrically isolated from the valve actuator and adapted to at least mechanically mate to the electrical harness in a manner that is at least substantially identical to the manner in which the electrical connector mechanically mates to the main connector port.

2. The valve assembly of claim 1, wherein the dummy connector port is lighter in weight than the main connector port.

3. The valve assembly of claim 2, wherein the dummy connector port comprises a material that is lighter in weight than that of the main connector port.

4. The valve assembly of claim 3, wherein the dummy connector port comprises a plastic.

5. A method of manufacturing a valve assembly, comprising the steps of:
forming a valve body having a fluid inlet, a fluid outlet, and a flow passage between the fluid inlet and the fluid outlet;
disposing a valve element at least partially within the flow passage;
mounting a valve actuator on the valve body;
coupling the valve actuator to the valve element, the valve actuator adapted to receive actuator commands and operable, upon receipt of the actuator commands, to move the valve element to a closed position or an open position;
coupling a main connector port to the valve body, the main connector adapted to mechanically and electrically mate to an electrical harness;
electrically coupling the main connector port to the valve actuator; and
coupling a dummy connector port to the valve body, the dummy connector port adapted to at least mechanically mate to the electrical harness in a manner that is at least substantially identical to the manner in which the electrical connector mechanically mates to the main connector port,
wherein the dummy connector port remains electrically isolated from the valve actuator.

6. The method of claim 5, further comprising:
disposing the dummy connector port at least proximate the main connector port on the valve body.

7. A valve control system, comprising:
an electrical harness coupled to receive and transmit electrical valve actuator commands; and
a valve assembly comprising:
a valve body having a fluid inlet, a fluid outlet, and a flow passage between the fluid inlet and the fluid outlet;
a valve element disposed at least partially within the flow passage and moveable between a closed position and an open position;
a valve actuator mounted on the valve body and coupled to the valve element, the valve actuator coupled to receive the electrical actuator commands and operable, upon receipt of the actuator commands, to move the valve element to the closed position or the open position;
a main connector port coupled to the valve body and electrically coupled to the valve actuator, the main connector port mechanically and electrically mated with the electrical harness; and
a dummy connector port coupled to the valve body, the dummy connector port electrically isolated from the valve actuator and adapted to at least mechanically mate to the electrical harness in a manner that is at least substantially identical to the manner in which the electrical connector mechanically mates to the main connector port,
wherein, when the electrical harness mates with the dummy connector port, any electrical valve actuator commands received by the electrical harness are not electrically coupled to the valve actuator.

8. The system of claim 7, wherein the dummy connector port is disposed proximate the main connector port.
